(19) United States
(12) Patent Application Publication
(10) Pub. No.: US 2014/0079866 A1
(43) Pub. Date: Mar. 20, 2014

(54) MILK AND DAIRY PRODUCTS CONTAINING OMEGA-3 AND OMEGA-6 HUFAS AND PASTEURIZATION PROCESSES THEREOF

(71) Applicants: Wei Wang-Nolan, Sharon, MA (US); Pablo Pena, Alexandria, VA (US); Robin Rebecca Rohwer, Columbia, MD (US)

(72) Inventors: Wei Wang-Nolan, Sharon, MA (US); Pablo Pena, Alexandria, VA (US); Robin Rebecca Rohwer, Columbia, MD (US)

(21) Appl. No.: 14/003,894

(22) PCT Filed: Mar. 9, 2012
(86) PCT No.: PCT/US12/28614

§ 371 Date: Nov. 26, 2013

(30) Foreign Application Priority Data
Mar. 9, 2011 (US) 61450858

(51) Int. Cl. A23C 3/02

(52) U.S. Cl. CPC A23C 3/02
USPC 426/585

(57) ABSTRACT

The invention relates to processes for pasteurizing a milk or dairy product supplemented with one or more omega-3 or omega-6 highly unsaturated fatty acids (HUFAs) in which the milk or dairy product is heated, and then heated to a sterilization temperature. Milk or dairy product supplemented with one or more omega-3 or omega-6 HUFAs and produced by a process of the invention has increased stability.

### BACKGROUND OF THE INVENTION

1. Field of the Invention

The invention relates to processes for pasteurizing milk or dairy products supplemented with one or more omega-3 or omega-6 highly unsaturated fatty acids (HUFAs) in which the milk is heated, and then heated to a sterilization temperature. Milk or dairy product supplemented with one or more omega-3 or omega-6 HUFAs and produced by processes of the invention has increased stability (e.g., increased shelf life).

2. Background Art

Supplementation with omega-3 and omega-6 highly unsaturated fatty acids (HUFAs) is important for pre-term infant growth and development. Several studies have also documented similar benefits to full-term infants. Omega-3 and omega-6 supplementation has also been linked to a variety of health benefits in adults, including reduced triglyceride levels, heart rate, blood pressure, and atherosclerosis.

One way to achieve dietary supplementation of omega-3 or omega-6 HUFAs is to supplement milk or dairy products with omega-3 or omega-6 HUFAs. However, a limitation to the production of milk or dairy products supplemented with omega-3 or omega-6 HUFAs is that such products are far less stable (e.g., having a reduced product shelf life) than milk or dairy products that do not contain omega-3 or omega-6 HUFAs, particularly with regard to skim milk products. Reduced product shelf life can be measured (e.g., by a difference from control sensory method) by the development of a fishy aroma or aromatics, or an egg-like aroma or aromatics, which occur when omega-3 or omega-6 HUFAs, respectively, are oxidized. Because omega-3 or omega-6 HUFAs are highly susceptible to oxidation, it has traditionally been difficult to incorporate them into food and beverage formulations. Antioxidants can function as free radical scavengers and can inhibit omega-3 or omega-6 HUFAs oxidation. Fats, when present, can dilute HUFA to a lower concentration and thus make it more stable. However, there remains a need for milk supplemented with omega-3 or omega-6 HUFAs that has improved stability (e.g., longer shelf life, reduced omega-3 or omega-6 HUFAs oxidation, or reduced undesirable off flavor).

### BRIEF SUMMARY OF THE INVENTION

The present invention is directed to processes for pasteurizing milk or dairy products comprising omega-3 or omega-6 highly unsaturated fatty acids (HUFAs), comprising (a) heating the milk or dairy product to a temperature of (i) at least 175° F. for more than 60 seconds, or (ii) greater than 215° F. for at least 0.1 second; and (b) heating the milk or dairy product to a sterilization temperature. In some embodiments, the milk or dairy product has a shelf life of at least 21 days.

The present invention is also directed to a milk or dairy product processed by the processes for pasteurizing described herein.

In addition, the present invention is directed to a milk or dairy product comprising omega-3 or omega-6 HUFAs, wherein the milk or dairy product has a shelf life of at least 21 days and contains less than 0.5% by weight of fat on a wet basis.

### BRIEF DESCRIPTION OF DRAWINGS

FIG. 1 is a flow diagram of a conformation of a MicroThermics™ pasteurization process described herein.

### DETAILED DESCRIPTION OF THE INVENTION

Milk is a highly nutritious food, and thus also serves as an excellent growth medium for microorganisms, most of which are capable of deteriorating or spoiling milk or milk products. Unprocessed milk can harbor microorganisms and/or pathogens. Pasteurization is a process for heat treating milk or milk products to kill these microorganisms and/or pathogens. Pasteurization processes are well known and require that the milk or milk product be heated to a temperature for an adequate length of time sufficient to render it free of microorganisms and/or pathogens. The present invention relates to apparatuses and processes for increasing the stability of milk or dairy products supplemented with omega-3 or omega-6 HUFAs using a pasteurization technique for heating milk (or other dairy product) that results in a milk or dairy product having improved stability (e.g., longer shelf life, reduced omega-3 or omega-6 HUFA oxidation, reduced fishy or eggy aroma or aromatics).

As described further herein, the present invention relates to a process for pasteurizing a milk or dairy product comprising omega-3 or omega-6 HUFAs, comprising (a) heating the milk or dairy product to a temperature of (i) at least 175° F. for more than 60 seconds, or (ii) greater than 215° F. for at least 0.1 second; and (b) heating the milk or dairy product of (a) to a temperature of 275° F. to 305° F. for at least 1 second, wherein the milk or dairy product has an increased shelf life compared to a milk or dairy product that has not been pasteurized by a process of the present invention. The present invention also relates to a process for pasteurizing a milk or dairy product comprising omega-3 or omega-6 HUFAs, comprising (a) heating the milk or dairy product to a temperature of (i) at least 175° F. for more than 60 seconds, or (ii) greater than 215° F. for at least 0.1 second; and (b) heating the milk or dairy product of (a) to a temperature of 275° F. to 305° F. for at least 1 second, wherein the milk or dairy product has a shelf life of at least 21 days. The present invention also relates to a milk or dairy product comprising omega-3 or omega-6 HUFAs, wherein the milk or dairy product has a shelf life of at least 21 days and contains less than 0.5% by weight of fat a wet basis.

### DEFINITIONS

As used herein, a “highly unsaturated fatty acid” or “HUFA” means a fatty acid having multiple carbon-carbon double bonds within the fatty acid chain. HUFAs include omega-3 HUFAs, omega-6 HUFAs, and mixtures thereof. HUFAs also include an omega-3 HUFA, an omega-6 HUFA, and mixtures thereof having two or more double bonds. HUFAs can be in the form of phospholipids, monoacylglycerols, diacylglycerols, triacylglycerols (Food Chemistry, third edition, Fennema, 1996), free fatty acids, free acids, salts, esters and/or other derivatives thereof.

Fatty acids can be represented by a simple numerical expression consisting of two terms separated by a colon, with the first term depicting the number of carbon atoms and the second term illustrating the number of double bonds. By convention, it is acceptable to distinguish unsaturated fatty acids by the location of the first double bond from the methyl end of the molecule, the omega carbon (Food Chemistry, third edition, Fennema, 1996). Omega-3 HUFAs contain 2 or more double bonds, the first double bond is located on the third carbon from the methyl end. Omega-3 HUFAs include, for example, docosahexaenoic acid C22:6(n-3) (DHA), docosapentaenoic acid C22:5(n-3) (DPAn-3), eicosapentaenoic acid C20:5(n-3) (EPA), stearidonic acid C18:4(n-3) (SDA), linolenic acid C18:3(n-3) (LNA), and mixtures thereof.

As used herein, an “omega-6 HUFA” contains 2 or more double bonds, the first double bond is located on the sixth carbon from the methyl end of the fatty acid and include, for example, arachidonic acid C20:4(n-6) (ARA), C22:4(n-6), omega-6 docosapentaenoic acid C22:5(n-6) (DPAn-6), gamma linolenic acid C18:3(n-6) (GLA), dihomo gamma linolenic acid C20:3(n-6) (dihomo GLA), and mixtures thereof.

As used herein, “docosahexaenoic acid” and “DHA” are used interchangeably to refer to the compound with the chemical name (all-Z)-4,7,10,13,16,19-docosahexaenoic acid, in any form described herein with regard to other HUFAs.

As used herein, the term “milk” refers to, for example, a mammary gland secretion of an animal that forms a natural food. Milk-producing animals include, for example, ruminants such as cows, sheep, goats, bison, buffalo, antelope, deer, and camel, as well as other non-ruminant animals and humans. Milk includes, for example, “whole milk” (e.g., milk having greater than 2% by weight of fat on a wet basis), “2% reduced fat milk” (e.g., milk having greater than 1% and up to 2% by weight of fat on a wet basis), “1% reduced fat milk” (e.g., milk having greater than 0.5% and up to 1% by weight of fat on a wet basis), or “fat free milk” (e.g., milk having 0% to 0.5% by weight of fat on a wet basis). Milk can include, for example, non-animal milks such as soy milk, rice milk, and almond milk. Milk can be, for example, in a liquid or powder form. Milk can be, for example, a “low pH milk” having a pH of 5 or less. Examples of a low pH milk include, for example, a milk having a pH of 4.5 or less, 4 or less, 3.5 or less, or 3 or less, or a pH of 3 to 5, 3.5 to 4.5, or 3.8 to 4.2. Milk can be, for example, a “milk drink” or “milk beverage” which, by definition, does not meet the federal standards for the identity of milk under 21 C.F.R. §131.110.

As used herein, “dairy product” is a food product wherein one of the major constituents is, or is derived from, a milk as described herein. Such products include, but are not limited to, yogurt, sour milk, cream, half & half, butter, condensed milk, dehydrated milk, coffee whitener, coffee creamer, nondairy creamer, smoothies, ice cream, kefir, cottage cheese and sports beverages.

As used herein, “increased stability” of a milk or dairy product of the invention includes, for example, a milk or dairy product subjected to pasteurization processes of the present invention having an increased shelf life, reduced HUFA oxidation, increased antioxidant levels (e.g., resulting from a Maillard reaction), and/or reduced fishy aroma or aromatics (e.g., as determined by sensory testing) compared to a milk or dairy product that is not subjected to the sterilization processes of the present invention. This term also includes a milk or dairy product of the invention that has a shelf life of at least 21 days, and/or has no fishy aroma or aromatics by at least 21 days, as described further herein.

### Pasteurization

The present invention relates to processes for pasteurizing a milk or dairy product supplemented with one or more omega-3 or omega-6 HUFAs. Apparatuses and processes for the pasteurization of milk and dairy products are well known in the art and are described further herein.

In some embodiments, the initial material for a pasteurization process of the invention is a fresh, untreated, or raw milk, but a pasteurization process of the invention can also be applied to a processed milk, such as that already subjected to pasteurization, but which has not realized the properties of a milk of the invention as described herein. In some embodiments, a milk to be processed can first be directed (e.g., by tubing) through a preheat exchanger to adjust the milk to a suitable temperature (i.e., a preheat temperature as described further herein). Following the preheat exchanger, the milk can be directed to a holding area to adjust the milk to a suitable temperature for sterilization (i.e., a sterilization temperature as described farther herein). The adjustments to suitable temperatures for preheating or sterilizing can be performed by direct or indirect heating (e.g., by injecting steam to milk directly or using steam as the heat medium in a tube and shell type of heat exchange for indirect heating). In some embodiments, steam injection into a milk is obtained either with an injector directly admitting steam to the milk in transit, or with an infuser comprising a chamber into which the milk falls, forming a film while steam is being admitted to the chamber. Following sterilization, the milk can be directed to a homogenizer. Following homogenization, the milk can be packaged for distribution. In some embodiments, homogenization of the milk can occur before sterilization.

Most modern dairies employ a continuous process pasteurization technique or a batch process pasteurization technique. An example of a continuous process pasteurization technique is continuous process high-temperature, short time (HTST) technique. In a HTST set up, cold raw milk is supplied from a tank and passed through a pump that delivers the milk under pressure to a heating element for preheating. Heating can occur by either a plate heat exchanger, or “press,” in which parallel plates define flow channels for the milk and for heating, or can employ a tubular heat exchanger in which two or more tubes of different diameter are arranged coaxially to define flow paths for the milk and other heat transfer media. The milk, having reached a preheating temperature, then flows through a holding tube, where the milk is held at a pasteurization temperature for a predetermined time. The velocity of the milk product is determined by the speed of the pump, the diameter and length of the holding tube, and other sources of surface friction. After passing temperature sensors at the end of the holding tube, the milk flows past a flow diversion device, which is intended to return the milk product through a divert line to the balance tank if the temperature of the product is below the preset pasteurization temperature. Properly heated milk will continue forward.

A homogenizer can be used to treat properly heated milk at this stage. Homogenization is employed to break up butterfat globules so that they will remain in suspension in the aqueous portion of the milk or other dairy product. A homogenizer can placed at the phase of the pasteurizer where the milk or other dairy product has been heated to the temperature of at least 175° F. The homogenizer consists of a pump where pistons move the milk at a prescribed flow rate and raise the pressure to several thousand PSI, and a screen, orifice, or equivalent means which the milk product is forced through to break up the fat globules.

Ultra high temperature treatment, i.e., UHT pasteurization, involves heating a product continuously, and ensuring that every particle of the milk or other food product has been held at the predetermined ultrahigh temperature for a minimum length of time. The UHT technique can be incorporated into a sterilization technique, in which the product is heated to a temperature of 240° F. or above, and is held for a corresponding holding time to ensure that the microorganisms and their spores in the product are destroyed. Then the sterilized product is packaged aseptically, and aseptically sealed, for example, in a clean-fill hood.

A vacuum treatment is sometimes employed to remove as much of the undesirable flavor components as possible from the product. In a vacuum process, milk is first heated to the desired temperature, and then is passed into a chamber in which the pressure has been reduced by a partial vacuum. The pressure in the chamber is low enough to cause the volatile flavor components to vaporize, and these are then evacuated from the chamber. Some of the water in the product may be evaporated as well. Vacuum treatment reduces flavor components that result from the cows′ ingestion of weeds or flavor-producing feed components.

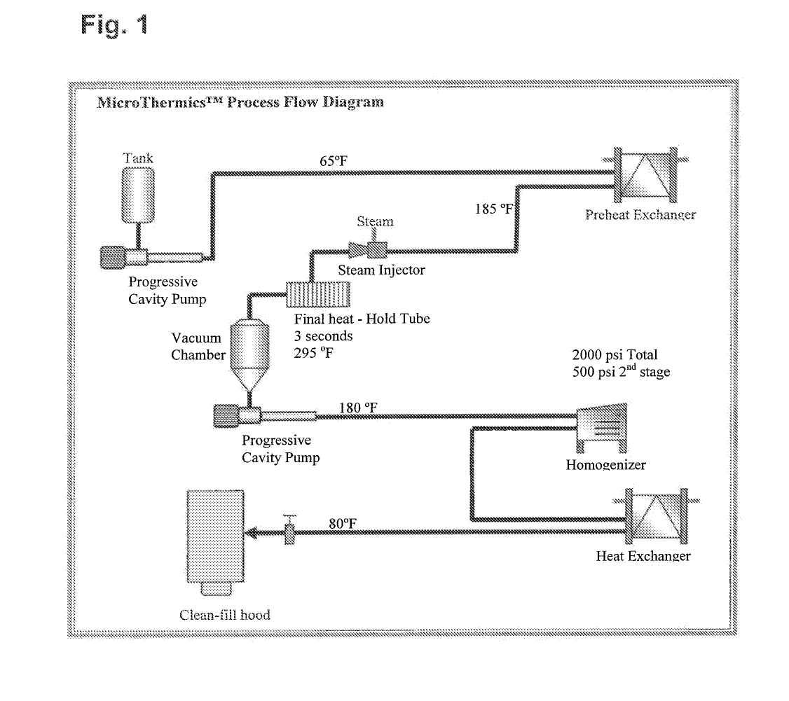

An example of an apparatus for pasteurization is shown in FIG. 1.

In some embodiments, a process for pasteurization of a milk or dairy product comprises heating a milk or dairy product to a first temperature (i.e., a preheat temperature) and then heating the milk or dairy product to second temperature (i.e., a sterilization temperature). In some embodiments, a process for pasteurization comprises (a) heating a milk or dairy product to a temperature of (i) at least 175° F. for more than 60 seconds, or (ii) greater than 215° F. for at least 0.1 second; and (b) sterilizing the milk or dairy product of (a). In some embodiments, the invention relates to a process for increasing the stability of milk or dairy product supplemented with at least one omega-3 or omega-6 HUFA, comprising (a) heating the milk or dairy product to a temperature of (i) at least 175° F. for more than 60 seconds, or (ii) greater than 215° F. for at least 0.1 second; and (b) heating the milk or dairy product of (a) to a temperature of 260° F. for at least 1 second.

In some embodiments, a process of the invention in (a) comprises heating a milk or dairy product to a temperature of at least 175° F., at least 180° F., at least 185° F., at least 190° F., at least 195° F., at least 200° F., at least 205° F., at least 210° F., at least 215° F., at least 220° F., at least 225° F., at least 230° F., at least 235° F., at least 240° F., at least 245° F., at least 250° F., at least 255° F., at least 260° F., at least 265° F., at least 270° F., at least 275° F., at least 280° F., at least 290° F., at least 295° F. and at least 300° F., and useful ranges can be selected between any of these values (for example, from 175° F. to 300° F., 175° F. to 250° F., 185° F. to 245° F., 205° F. to 245° F., 215° F. to 245° F., 225° F. to 245° F., 205° F. to 225° F., 215° F. to 225° F., 185° F. to 205° F., 185° F. to 215° F. or 185° F. to 225° F.). In some embodiments, the process in (a) comprises heating for at least 0.1 second, at least 0.2 second, at least 0.3 second, at least 0.4 second, at least 0.5 second, at least 0.6 second, at least 0.7 second, at least 0.8 second, at least 0.9 second, at least 1 second, at least 2 seconds, at least 3 seconds, at least 4 seconds, at least 5 seconds, at least 6 seconds, at least 7 seconds, at least 8 seconds, at least 9 seconds, at least 10 seconds, at least 15 seconds, at least 20 seconds, at least 25 seconds, at least 30 seconds, at least 35 seconds, at least 40 seconds, at least 45 seconds, at least 50 seconds, at least 55 seconds, at least 60 seconds, at least 65 seconds, at least 70 seconds, at least 75 seconds, at least 80 seconds, at least 85 seconds, at least 90 seconds, at least 95 seconds, at least 100 seconds, at least 110 seconds, at least 120 seconds, at least 130 seconds, at least 140 seconds, at least 150 seconds, at least 160 seconds, at least 170 seconds, at least 180 seconds, at least 190 seconds, at least 200 seconds, at least 210 seconds, at least 220 seconds, at least 230 seconds, at least 240 seconds, at least 250 seconds, at least 260 seconds, at least 270 seconds, at least 280 seconds, at least 290 seconds, at least 300 seconds, at least 310 seconds, at least 320 seconds, at least 330 seconds, at least 340 seconds, at least 350 seconds, at least 360 seconds, at least 370 seconds, at least 380 seconds, at least 390 seconds, or at least 400 seconds, and useful ranges can be selected between any of these values (for example, from 0.1 second to 400 seconds, 3 seconds to 45 seconds, 3 seconds to 15 seconds, 90 seconds to 300 seconds, 180 seconds to 300 seconds, 210 seconds to 300 seconds, 240 seconds to 300 seconds, 90 seconds to 180 seconds, 90 seconds to 210 seconds, 90 seconds to 240 seconds, 180 seconds to 210 seconds, 180 seconds to 240 seconds, 210 seconds to 240 seconds, 15 seconds to 45 seconds, 15 seconds to 90 seconds, 60 seconds to 90 seconds, 60 seconds to 300 seconds, 15 seconds to 180 seconds, 15 seconds to 180 seconds, 15 seconds to 210 seconds, or 15 seconds to 240 seconds). In some embodiments, the process in (a) can promote a Maillard reaction, result in reduced HUFA oxidation, and/or result in increased antioxidant levels.

In some embodiments, a process of the invention in (b) comprises heating a milk or dairy product to a temperature of at least 260° F., at least 265° F., at least 270° F., at least 275° F., at least 280° F., at least 285° E, at least 290° F., at least 295° F., at least 300° F., at least 305° F., at least 310° F., at least 315° F., or at least 320° F., and useful ranges can be selected between any of these values (for example, from 260° F. to 320° F., or 275° F. to 305° F.). In some embodiments, the process in (b) comprises heating for at least 1 second, 2 seconds, 3 seconds, 4 seconds, 5 seconds, 6 seconds, 7 seconds, 8 seconds, 9 seconds, 10 seconds, 11 seconds, 12 seconds, 13 seconds, 14 seconds, 15 seconds, 16 seconds, 17 seconds, 18 seconds, 19 seconds, or 20 seconds, and useful ranges can be selected between any of these values (for example, from 1 second to 20 seconds, 1 second to 15 seconds, 1 second to 10 seconds, 1 second to 5 seconds, 1 second to 4 seconds, 1 second to 3 seconds, 1 second to 2 seconds, 2 seconds to 3 seconds, 2 seconds to 4 seconds, 2 seconds to 5 seconds, 3 seconds to 4 seconds, 3 seconds to 5 seconds, or 4 seconds to 5 seconds).

In some embodiments, a process of the invention comprises (a) heating a milk or dairy product to a temperature of 175° F. to 300° F. for 60 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 175° F. to 250° F. for 60 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 185° F. to 245° F. for 60 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 185° F. to 205° F. for 240 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 225° F. to 245° F. for 60 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 185° F. to 215° F. for 60 seconds to 300 seconds; and (b) heating the milk or dairy product of (a) to a temperature of 275° F. to 302° F. for 1 second to 5 seconds.

In some embodiments, a process of the invention comprises (a) heating a milk or dairy product to a temperature of 205° F. to 245° F. for 60 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 215° F. to 245° F. for 60 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 205° F. to 225° F. for 60 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 215° F. to 225° F. for 60 seconds to 300 seconds; and (b) heating the milk or dairy product of (a) to a temperature of 275° F. to 302° F. for 1 second to 5 seconds. In some embodiments, a process of the invention comprises (a) heating a milk or dairy product to a temperature of 185° F. to 225° F. for 60 seconds to 300 seconds; and (b) heating the milk or dairy product of (a) to a temperature of 275° F. to 302° F. for 1 second to 5 seconds.

In some embodiments, a process of the invention comprises (a) heating a milk or dairy product to a temperature of greater than 215° F. for at least 0.1 second; and (b) heating the milk or dairy product of (a) to a temperature of 275° F. to 302° F. for at least 1 second. In some embodiments, a process of the invention comprises (a) heating a milk or dairy product to a temperature of greater than 215° F. for at least 3 seconds; and (b) heating the milk or dairy product of (a) to a temperature of 275° F. to 302° F. for at least 1 second. In some embodiments, a process of the invention comprises (a) heating a milk or dairy product to a temperature of 225° F. to 245° F. for 3 seconds to 45 seconds; and (b) heating the milk or dairy product of (a) to a temperature of 275° F. to 302° F. for 1 second to 5 seconds. In some embodiments, a process of the invention comprises (a) heating a milk or dairy product to a temperature of 225° F. to 245° F. for 3 seconds to 15 seconds; and (b) heating the milk or dairy product of (a) to a temperature of 275° F. to 302° F. for 1 second to 5 seconds. In some embodiments, a process of the invention comprises (a) heating a milk or dairy product to a temperature of 225° F. to 245° F. for 15 seconds to 45 seconds; and (b) heating the milk or dairy product of (a) to a temperature of 275° F. to 302° F. for 1 second to 5 seconds.

The resulting milk or dairy product of a process of the invention can have improved stability compared to a milk or dairy product that is not the result of a process of the invention. In some embodiments, the resulting milk or dairy product has an increased shelf life compared to a milk or dairy product that is not the result of a process of the invention. In some embodiments, the resulting milk or dairy product has reduced HUFA oxidation levels compared to a milk or dairy product that is not the result of a process of the invention. In some embodiments, the resulting milk or dairy product has increased antioxidant levels compared to a milk or dairy product that is not the result of a process of the invention. In some embodiments, the increased antioxidant levels are the result of a Maillard reaction. In some embodiments, the resulting milk or dairy product has reduced fishy aroma or aromatics (e.g., by sensory testing) compared to a milk or dairy product that is not the result of a process of the invention.

In some embodiments of the invention, the resulting milk or dairy product has a shelf life of at least 21 days, at least 22 days, at least 23 days, at least 24 days, at least 25 days, at least 26 days, at least 27 days, at least 28 days, at least 29 days, at least 30 days, at least 31 days, at least 32 days, at least 33 days, at least 34 days, at least 35 days, at least 36 days, at least 37 days, at least 38 days, at least 39 days, at least 40 days, at least 41 days, at least 42 days, at least 43 days, at least 44 days, at least 45 days, at least 46 days, at least 47 days, at least 48 days, at least 49 days, at least 50 days, at least 51 days, at least 52 days, at least 53 days, at least 54 days, at least 55 days, at least 56 days, at least 57 days, at least 58 days, at least 59 days, at least 60 days, at least 61 days, at least 62 days, at least 63 days, at least 64 days, at least 65 days, at least 66 days, at least 67 days, at least 68 days, at least 69 days, at least 70 days, at least 71 days, at least 72 days, at least 73 days, at least 74 days, at least 75 days, at least 76 days, at least 77 days, at least 78 days, at least 79 days, or at least 80 days, and useful ranges can be selected between any of these values (for example, from 21 days to 60 days, 30 days to 60 days, 45 days to 60 days, or 30 days to 45 days).

In some embodiments, the invention relates to an apparatus for producing a milk or dairy product of the invention comprising a preheat exchanger and a steam injector. See, e.g., FIG. 1. In some embodiments, an apparatus for producing a milk or dairy product of the invention comprises a preheat exchanger for heating a milk or dairy product of the invention to a temperature of (i) at least 175° F. for more than 60 seconds, or (ii) greater than 215° F. for at least 0.1 second, and a steam injector for heating a milk or dairy product of the invention for pasteurization as described herein. In some embodiments, the apparatus further comprises a vacuum chamber for sudden cooling of the sterilized milk or dairy product via evaporation.

Omega-3 and/or Omega-6 HUFAs for Supplementation

The present invention relates to milk or dairy product supplemented with omega-3 or omega-6 HUFAs that has improved stability (e.g., longer shelf life, reduced omega-3 or omega-6 HUFA oxidation, increased antioxidants, or reduced fishy aroma or aromatics). In some embodiments, omega-3 HUFAs comprise at least one of docosahexaenoic acid C22:6(n-3) (DHA), docosapentaenoic acid C22:5(n-3) (DPAn-3), eicosapentaenoic acid C20:5(n-3) (EPA), stearidonic acid C18:4(n-3) (SDA), and linolenic acid C18:3(n-3) (LNA). In some embodiments, an omega-3 HUFA comprises DHA.

In some embodiments, omega-6 HUFAs comprise at least one of arachidonic acid C20:4(n-6) (ARA), C22:4(n-6), omega-6 docosapentaenoic acid C22:5(n-6) (DPAn-6), gamma linolenic acid C18:3(n-6) (GLA), and dihomo gamma linolenic acid C20:3(n-6) (dihomo GLA). In some embodiments, omega-6 HUFAs comprise at least one of DPA(n-6) and ARA. In some embodiments, omega-6 HUFAs comprise DPA(n-6).

Any source of omega-3 and/or omega-6 HUFAs can be used in the compositions and processes of the present invention, including, for example, animal, plant and microbial sources. Sources of omega-3 or omega-6 HUFAs and methods for processing and isolating omega-3 or omega-6 HUFAs include those described in U.S. Pat. No. 5,340,594 and in U.S. Pat. No. 5,698,244, both of which are incorporated herein by reference in their entireties. For example, strains of fungi, algae or protists can be isolated that contain omega-3 or omega-6 HUFAs.

Omega-3 or omega-6 HUFAs can be derived from various sources, e.g., from oleaginous microorganisms. As used herein, “oleaginous microorganisms” are defined as microorganisms capable of accumulating greater than 20% of the dry weight of their cells in the form of lipids. In some embodiments, omega-3 or omega-6 HUFAs are derived from a phototrophic or heterotrophic single cell organism or multicellular organism, e.g., an algae. For example, omega-3 or omega-6 HUFAs can be derived from an algal source. In some embodiments, the algal source is Crypthecodinium cohnii or Schizochytrium sp. golden algae (e.g., microorganisms of the kingdom Stramenopiles), green algae, diatoms, dinoflagellates (e.g., microorganisms of the order Dinophyceae including members of the genus Crypthecodinium such as, for example, Crypthecodinium cohnii or C. cohnii), yeast (Ascomycetes or Basidiomycetes), and fungi of the genera Mucor and Mortierella, including but not limited to Mortierella alpina and Mortierella sect. schmuckeri.

A source of omega-3 or omega-6 HUFAs can include a microbial source, including the microbial groups Stramenopiles, Thraustochytrids, and Labrinthulids. Stramenopiles includes microalgae and algae-like microorganisms, including the following groups of microorganisms: Hamatores, Proteromonads, Opalines, Develpayella, Diplophrys, Labrinthulids, Thraustochytrids, Biosecids, Oomycetes, Hypochytridiomycetes, Commation, Reticulosphaera, Pelagomonas, Pelagococcus, Ollicola, Aureococcus, Patinales, Diatoms, Xanthophytes, Phaeophytes (brown algae), Eustigmatophytes, Raphidophytes, Synurids, Axodines (including Rhizochromulinaales, Pedinellales, Dictyochales), Chrysomeridales, Sarcinochrysidales, Hydrurales, Hibberdiales, and Chromulinales. The Thraustochytrids include the genera Schizochytrium (species include aggregatum, limnaceum, mangrovei, minutum, octosporum), Thraustochytrum (species include arudimentale, aureum, benthicola, globosum, kinnei, motivam, multirudimentale, pachyderrium, proliferum, roseum, striatum), Ulkenia (species include amoeboidea, kerguelensis, minuta, profunda, radiate, sailens, sarkariana, schizochytrops, visurgensis, yorkensis), Aplanochytrium (species include haliotidis, kerguelensis, profunda, stocchinoi), Japonochytrium (species include marinum), Althornia (species include crouchii), and Elina (species include marisalba, sinorifica). The Labrinthulids include the genera Labyrinthula (species include algeriensis, coenocystis, chattonii, macrocystis, macrocystis atlantica, macrocystis macrocystis, marina, minuta, roscofJensis, valkanovii, vitellina, vitellina pacifica, vitellina vitellina, zopfi), Labyrinthomyxa (species include marina), Labyrinthuloides (species include haliotidis, yorkensis), Diplophrys (species include archeri), Pyrrhosorus* (species include marinus), Sorodiplophrys* (species include stercorea), and Chlamydomyxa* (species include labyrinthuloides, montana) (*=there is no current general consensus on the exact taxonomic placement of these genera).

A source of omega-3 or omega-6 HUFAs can include an algal or microalgal source. Microalgae, also known as microscopic algae, are often found in freshwater and marine systems. Microalgae are unicellular but can also grow in chains and groups. Individual cells range in size from a few micrometers to a few hundred micrometers.

In some embodiments, the microalgae is a heterokont or stramenopile. In some embodiments, the microalgae is a member of the phylum Labyrinthulomycota. In some embodiments, the Labyrinthulomycota host cell is a member of the order Thraustochytriales or the order Labyrinthulales. According to the present invention, the term “thraustochytrid” refers to any member of the order Thraustochytriales, which includes the family Thraustochytriaceae, and the term “labyrinthulid” refers to any member of the order Labyrinthulales, which includes the family Labyrinthulaceae. Members of the family Labyrinthulaceae were previously considered to be members of the order Thraustochytriales, but in more recent revisions of the taxonomic classification of such organisms, the family Labyrinthulaceae is now considered to be a member of the order Labyrinthulales. Both Labyrinthulales and Thraustochytriales are considered to be members of the phylum Labyrinthulomycota. Taxonomic theorists now generally place both of these groups of microorganisms with the algae or algae-like protists of the Stramenopile lineage. The current taxonomic placement of the thraustochytrids and labyrinthulids can be summarized as follows:

```
Realm: Stramenopila (Chromista)
      Phylum: Labyrinthulomycota (Heterokonta)
            Class: Labyrinthulomycetes (Labyrinthulae)
                  Order: Labyrinthulales
                        Family: Labyrinthulaceae
                  Order: Thraustochytriales
                        Family: Thraustochytriaceae
```

For purposes of the present invention, thraustochytrids include the following organisms: Order: Thraustochytriales; Family: Thraustochytriaceae; Genera: Thraustochytrium (Species: sp., arudimentale, aureum, benthicola, globosum, kinnei, motivum, multirudimentale, pachydermum, proliferum, roseum, striatum), Ulkenia (Species: sp., amoeboidea, kerguelensis, minuta, profunda, radiata, sailens, sarkariana, schizochytrops, visurgensis, yorkensis), Schizochytrium (Species: sp., aggregatum, limnaceum, mangrovei, minutum, octosporum), Japonochytrium (Species: sp., marinum), Aplanochytrium (Species: sp., haliotidis, kerguelensis, profunda, stocchinoi), Althornia (Species: sp., crouchii), or Elina (Species: sp., marisalba, sinorifica). For the purposes of this invention, Ulkenia will be considered to be members of the genus Thraustochytrium. Aurantiochytrium, Oblongichytrium, Botryochytrium, Parietichytrium, and Sicyoidochytrium are additional genuses encompassed by the phylum Labyrinthulomycota in the present invention.

Labyrinthulids include the following organisms: Order: Labyrinthulales, Family: Labyrinthulaceae, Genera: Labyrinthula (Species: sp., algeriensis, coenocystis, chattonii, macrocystis, macrocystis atlantica, macrocystis macrocystis, marina, minuta, roscoffensis, valkanovii, vitellina, vitellina pacifica, vitellina vitellina, zopfii), Labyrinthuloides (Species: sp., haliotidis, yorkensis), Labyrinthomyxa (Species: sp., marina), Diplophrys (Species: sp., archeri), Pyrrhosorus (Species: sp., marinus), Sorodiplophrys (Species: sp., stercorea) or Chlamydomyxa (Species: sp., labyrinthuloides, montana) (although there is currently not a consensus on the exact taxonomic placement of Pyrrhosorus, Sorodiplophrys or Chlamydomyxa).

Microalgal cells of the phylum Labyrinthulomycota include, but are not limited to, deposited strains PTA-10212, PTA-10213, PTA-10214, PTA-10215, PTA-9695, PTA-9696, PTA-9697, PTA-9698, PTA-10208, PTA-10209, PTA-10210, PTA-10211, the microorganism deposited as SAM2179 (named “Ulkenia SAM2179” by the depositor), any Thraustochytrium species (including former Ulkenia species such as U. visurgensis, U. amoeboida, U. sarkariana, U. profunda, U. radiata, U. minuta and Ulkenia sp. BP-5601), and including Thraustochytrium striatum, Thraustochytrium aureum, Thraustochytrium roseum; and any Japonochytrium species. Strains of Thraustochytriales include, but are not limited to Thraustochytrium sp. (23B) (ATCC 20891); Thraustochytrium striatum (Schneider) (ATCC 24473); Thraustochytrium aureum (Goldstein) (ATCC 34304); Thraustochytrium roseum (Goldstein) (ATCC 28210); and Japonochytrium sp. (L1) (ATCC 28207). Schizochytrium include, but are not limited to Schizochytrium aggregatum, Schizochytrium limacinum, Schizochytrium sp. (S31) (ATCC 20888), Schizochytrium sp. (S8) (ATCC 20889), Schizochytrium sp. (LC-RM) (ATCC 18915), Schizochytrium sp. (SR 21), deposited strain ATCC 28209, and deposited Schizochytrium limacinum strain IFO 32693. In some embodiments, the microalgae is a Schizochytrium or a Thraustochytrium. Schizochytrium can replicate both by successive bipartition and by forming sporangia, which ultimately release zoospores. Thraustochytrium, however, replicate only by forming sporangia, which then release zoospores.

In some embodiments, the microalgae is a Labyrinthulae (also termed Labyrinthulomycetes). Labyrinthulae produce unique structures called “ectoplasmic nets.” These structures are branched, tubular extensions of the plasma membrane that contribute significantly to the increased surface area of the plasma membrane. See, for example, Perkins, Arch. Mikrobiol. 84:95-118 (1972); Perkins, Can. J. Bot. 51:485-491 (1973). Ectoplasmic nets are formed from a unique cellular structure referred to as a sagenosome or bothrosome. The ectoplasmic net attaches Labyrinthulae cells to surfaces and is capable of penetrating surfaces. See, for example, Coleman and Vestal, Can. J. Microbiol. 33:841-843 (1987), and Porter, Mycologia 84:298-299 (1992), respectively. Schizochytrium sp. ATCC 20888, for example, has been observed to produce ectoplasmic nets extending into agar when grown on solid media (data not shown). The ectoplasmic net in such instances appears to act as a pseudorhizoid. Additionally, actin filaments have been found to be abundant within certain ectoplasmic net membrane extensions. See, for example, Preston, J. Eukaryot. Microbiol. 52:461-475 (2005). Based on the importance of actin filaments within cytoskeletal structures in other organisms, it is expected that cytoskeletal elements such as actin play a role in the formation and/or integrity of ectoplasmic net membrane extensions.

Additional organisms producing pseudorhizoid extensions include organisms termed chytrids, which are taxonomically classified in various groups including the Chytridiomycota, or Phycomyces. Examples of genera include Chytrdium, Chytrimyces, Cladochytium, Lacustromyces, Rhizophydium, Rhisophyctidaceae, Rozella, Olpidium, and Lobulomyces.

In some embodiments, the microalgae comprises a membrane extension. In some embodiments, the microalgae comprises a pseudorhizoid. In some embodiments, the microalgae comprises an ectoplasmic net. In some embodiments, the microalgae comprises a sagenosome or bothrosome.

In some embodiments, the microalgae is a thraustochytrid. In some embodiments, the microalgae is a Schizochytrium or Thraustochytrium cell.

In some embodiments, the microalgae is a labyrinthulid.

In some embodiments, the microalgae is a eukaryote capable of processing polypeptides through a conventional secretory pathway, such as members of the phylum Labyrinthulomycota, including Schizochytrium, Thraustochytrium, and other thraustochytrids. For example, it has been recognized that members of the phylum Labyrinthulomycota produce fewer abundantly-secreted proteins than CHO cells, resulting in an advantage of using Schizochytrium, for example, over CHO cells. In addition, unlike E. coli, members of the phylum Labyrinthulomycota, such as Schizochytrium, perform protein glycosylation, such as N-linked glycosylation, which is required for the biological activity of certain proteins. It has been determined that the N-linked glycosylation exhibited by thraustochytrids such as Schizochytrium more closely resembles mammalian glycosylation patterns than does yeast glycosylation.

In some embodiments, the algal source is Crypthecodinium cohnii. Samples of C. cohnii have been deposited with the American Type Culture Collection at Rockville, Md., and assigned Accession Nos. 40750, 30021, 30334-30348, 30541-30543, 30555-30557, 30571, 30572, 30772-30775, 30812, 40750, 50050-50060, and 50297-50300.

In some embodiments, omega-3 or omega-6 HUFAs are provided in the form of a microbial or algal oil. In some embodiments, omega-3 or omega-6 HUFAs are provided in the form of an algal oil comprising docosahexaenoic acid (DHA). Such oils are commercially available and include DHA™-S, ARASCO®, DHASCO® and FORMULAID® oils (Martek Biosciences Corporation, Columbia, Md.).

In some embodiments, omega-3 or omega-6 HUFAs are provided from an algal source deposited with the American Type Culture Collection at Rockville, Md., and assigned Accession No. PTA-10212, PTA-10213, PTA-10214, PTA-10215, PTA-10208, PTA-10209, PTA-10210, or PTA-10211, or from an algal source disclosed in U.S. Pub. No. 2011/0177031, published Jul. 21, 2011.

In some embodiments, omega-3 or omega-6 HUFAs are provided from a microorganism that produces a triacylglycerol fraction, wherein the eicosapentaenoic acid content of the triacylglycerol fraction is at least about 12% by weight.

In some embodiments, omega-3 or omega-6 HUFAs are provided from a biomass wherein at least about 20% by weight of a dry cell weight of the biomass are fatty acids, wherein more than about 10% by weight of fatty acids is eicosapentaenoic acid, and wherein the fatty acids comprise less than about 5% by weight each of arachidonic acid and docosapentaenoic acid n-6. In some embodiments, omega-3 or omega-6 HUFAs are provided from a biomass wherein at least about 20% by weight of a dry cell weight of the biomass are fatty acids, wherein more than about 10% by weight of fatty acids is eicosapentaenoic acid, wherein the fatty acids comprise less than about 5% by weight each of arachidonic acid and docosapentaenoic acid n-6, and wherein at least about 25% by weight of the fatty acids is docosahexaenoic acid. In some embodiments, omega-3 or omega-6 HUFAs are provided from a biomass comprising triacylglycerol, wherein at least about 12% by weight of triacylglycerol is eicosapentaenoic acid. In some embodiments, the fatty acids of such biomasses further comprise less than about 5% by weight each of oleic acid, linoleic acid, linolenic acid, eicosenoic acid, and erucic acid.

In some embodiments, omega-3 or omega-6 HUFAs are provided from a microbial oil comprising at least about 20% by weight eicosapentaenoic acid and less than about 5% by weight each of arachidonic acid, docosapentaenoic acid n-6, oleic acid, linoleic acid, linolenic acid, eicosenoic acid, erucic acid, and stearidonic acid. In some embodiments, omega-3 or omega-6 HUFAs are provided from a microbial oil comprising at least about 20% by weight eicosapentaenoic acid and less than about 5% by weight each of arachidonic acid, docosapentaenoic acid n-6, oleic acid, linoleic acid, linolenic acid, eicosenoic acid, erucic acid, and stearidonic acid, and at least about 25% by weight docosahexaenoic acid. In some embodiments, omega-3 or omega-6 HUFAs are provided from a microbial oil comprising a triacylglycerol fraction of at least about 10% by weight, wherein at least about 12% by weight of the fatty acids in the triacylglycerol fraction is eicosapentaenoic acid, wherein at least about 25% by weight of the fatty acids in the triacylglycerol fraction is docosahexaenoic acid, and wherein less than about 5% by weight of the fatty acids in the triacylglycerol fraction is arachidonic acid.

In some embodiments, omega-3 or omega-6 HUFAs are provided from a microbial oil comprising a sterol esters fraction of about 0%, at least about 0.1%, at least about 0.2%, at least about 0.5%, at least about 1%, at least about 1.5%, at least about 2%, or at least about 5% by weight. In some embodiments, omega-3 or omega-6 HUFAs are provided from a microbial oil comprising a sterol esters fraction of about 0% to about 1.5%, about 0% to about 2%, about 0% to about 5%, about 1% to about 1.5%, about 0.2% to about 1.5%, about 0.2% to about 2%, or about 0.2% to about 5% by weight. In some embodiments, omega-3 or omega-6 HUFAs are provided from a microbial oil comprising a sterol esters fraction of about 5% or less, about 4% or less, about 3% or less, about 2% or less, about 1% or less, about 0.5% or less, about 0.3% or less, about 0.2% or less, about 0.5% or less, about 0.4% or less, about 0.3% or less, or about 0.2% or less by weight.

In some embodiments, omega-3 or omega-6 HUFAs are provided from a microbial oil comprising a triacylglycerol fraction of at least about 35%, at least about 40%, at least about 45%, at least about 50%, at least about 55%, at least about 60%, at least about 65%, at least about 70%, at least about 75%, at least about 80%, at least about 85%, or at least about 90% by weight. In some embodiments, omega-3 or omega-6 HUFAs are provided from a microbial oil comprising a triacylglycerol fraction of about 35% to about 98%, about 35% to about 90%, about 35% to about 80%, about 35% to about 70%, about 35% to about 70%, about 35% to about 65%, about 40% to about 70%, about 40% to about 65%, about 40% to about 55%, about 40% to about 50%, about 65% to about 95%, about 75% to about 95%, about 75% to about 98%, about 80% to about 95%, about 80% to about 98%, about 90% to about 96%, about 90% to about 97%, about 90% to about 98%, about 90%, about 95%, about 97%, or about 98% by weight.

In some embodiments, omega-3 or omega-6 HUFAs are provided from a microbial oil comprising a diacylglycerol fraction of at least about 10%, at least about 11%, at least about 12%, at least about 13%, at least about 14%, at least about 15%, at least about 16%, at least about 17%, at least about 18%, at least about 19%, or at least about 20% by weight. In some embodiments, omega-3 or omega-6 HUFAs are provided from a microbial oil comprising a diacylglycerol fraction of about 10% to about 45%, about 10% to about 40%, about 10% to about 35%, about 10% to about 30%, about 15% to about 40%, about 15% to about 35%, or about 15% to about 30% by weight. In some embodiments, omega-3 or omega-6 HUFAs are provided from a microbial oil comprising a 1,2-diacylglycerol fraction of at least about 0.2%, at least about 0.3%, at least about 0.4%, at least about 0.5%, at least about 1%, at least about 5%, at least about 10%, at least about 11%, at least about 12%, at least about 13%, at least about 14%, at least about 15%, at least about 16%, at least about 17%, at least about 18%, at least about 19%, or at least about 20% by weight. In some embodiments, omega-3 or omega-6 HUFAs are provided from a microbial oil comprising a diacylglycerol fraction of about 0.2% to about 45%, about 0.2% to about 30%, about 0.2% to about 20%, about 0.2% to about 10%, about 0.2% to about 5%, about 0.2% to about 1%, about 0.2% to about 0.8%, about 0.4% to about 45%, about 0.4% to about 30%, about 0.4% to about 20%, about 0.4% to about 10%, about 0.4% to about 5%, about 0.4% to about 1%, about 0.4% to about 0.8%, about 0.5% to about 1%, about 0.5% to about 0.8%, about 10% to about 45%, about 10% to about 40%, about 10% to about 35%, about 10% to about 30%, about 15% to about 40%, about 15% to about 35%, about 15% to about 30%, or about 15% to about 25% by weight. In some embodiments, omega-3 or omega-6 HUFAs are provided from a microbial oil comprising a 1,3-diacylglycerol fraction of at least about 0.1%, at least about 0.2%, at least about 0.5%, at least about 1%, at least about 2%, at least about 2.5%, or at least about 3% by weight. In some embodiments, omega-3 or omega-6 HUFAs are provided from a microbial oil comprising a sterol fraction of at least about 0.3%, at least about 0.4%, at least about 0.5%, at least about 1%, at least about 1.5%, at least about 2%, or at least about 5% by weight.

In some embodiments, omega-3 or omega-6 HUFAs are provided from a microbial oil comprising a sterol fraction of about 0.3% to about 5%, about 0.3% to about 2%, about 0.3% to about 1.5%, about 0.5% to about 1.5%, about 1% to about 1.5%, about 0.5% to about 2%, about 0.5% to about 5%, about 1% to about 2%, or about 1% to about 5% by weight. In some embodiments, omega-3 or omega-6 HUFAs are provided from a microbial oil comprising a sterol fraction of about 5% or less, about 4% or less, about 3% or less, about 2% or less, about 1.5% or less, or about 1% or less by weight.

In some embodiments, omega-3 or omega-6 HUFAs are provided from a microbial oil comprising a phospholipid fraction of at least about 2%, at least about 5%, or at least about 8% by weight. In some embodiments, omega-3 or omega-6 HUFAs are provided from a microbial oil comprising a phospholipid fraction of about 2% to about 25%, about 2% to about 20%, about 2% to about 15%, about 2% to about 10%, about 5% to about 25%, about 5% to about 20%, about 5% to about 20%, about 5% to about 10%, or about 7% to about 9% by weight. In some embodiments, omega-3 or omega-6 HUFAs are provided from a microbial oil comprising a phospholipid fraction of less than about 20%, less than about 15%, less than about 10%, less than about 9%, or less than about 8% by weight. In some embodiments, omega-3 or omega-6 HUFAs are provided from a microbial oil substantially free of phospholipids. In some embodiments, omega-3 or omega-6 HUFAs are provided from a microbial oil comprising unsaponifiables of less than about 2%, less than about 1.5%, less than about 1%, or less than about 0.5% by weight of the oil. The lipid classes present in the microbial oil, such as a triacylglycerol fraction, can be separated by flash chromatography and analyzed by thin layer chromatography (TLC), or separated and analyzed by other methods known in the art.

In some embodiments, omega-3 or omega-6 HUFAs are provided from a microbial oil and/or one or more fractions thereof selected from the triacylglycerol fraction, the free fatty acid fraction, the sterol fraction, the diacylglycerol fraction, and combinations thereof, comprising at least about 5%, at least about 10%, more than about 10%, at least about 12%, at least about 13%, at least about 14%, at least about 15%, at least about 16%, at least about 17%, at least about 18%, at least about 19%, at least about 20%, at least about 25%, at least about 30%, about least about 35%, at least about 40%, or at least about 45% by weight EPA. In some embodiments, omega-3 or omega-6 HUFAs are provided from a microbial oil and/or one or more fractions thereof selected from the triacylglycerol fraction, the free fatty acid fraction, the sterol fraction, the diacylglycerol fraction, and combinations thereof, comprising about 5% to about 55%, about 5% to about 50%, about 5% to about 45%, about 5% to about 40%, about 5% to about 35%, about 5% to about 30%, about 10% to about 55%, about 10% to about 50%, about 10% to about 45%, about 10% to about 40%, about 10% to about 35%, about 10% to about 30%, at least about 12% to about 55%, at least about 12% to about 50%, at least about 12% to about 45%, at least about 12% to about 40%, at least about 12% to about 35%, or at least about 12% to about 30%, about 15% to about 55%, about 15% to about 50%, about 15% to about 45%, about 15% to about 40%, about 15% to about 35%, about 15% to about 30%, about 15% to about 25%, about 15% to about 20%, about 20% to about 55%, about 20% to about 50%, about 20% to about 45%, about 20% to about 40%, or about 20% to about 30% by weight EPA. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, comprising at least about 5%, at least about 10%, at least about 15%, at least about 20%, at least about 25%, at least about 30%, at least about 35%, at least about 40%, at least about 50%, or at least about 60% by weight DHA. In some embodiments, omega-3 or omega-6 HUFAs are provided from a microbial oil and/or one or more fractions thereof selected from the triacylglycerol fraction, the diacylglycerol fraction, the sterol traction, the sterol esters fraction, the free fatty acids fraction, the phospholipid fraction, and combinations thereof, comprising about 5% to about 60%, about 5% to about 55%, about 5% to about 50%, about 5% to about 40%, about 10% to about 60%, about 10% to about 50%, about 10% to about 40%, about 20% to about 60%, about 25% to about 60%, about 25% to about 50%, about 25% to about 45%, about 30% to about 50%, about 35% to about 50%, or about 30% to about 40% by weight DHA. In some embodiments, omega-3 or omega-6 HUFAs are provided Loin a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, comprising about 10% or less, about 9% or less, about 8% or less, about 7% or less, about 6% or less, about 5% or less, about 4% or less, about 3% or less, about 2% or less, or about 1% or less by weight DHA. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, comprising about 1% to about 10%, about 1% to about 5%, about 2% to about 5%, about 3% to about 5%, or about 3% to about 10% by weight of the fatty acids as DHA. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, which is substantially free of DHA. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, comprising about 0.1% to about 5%, about 0.1% to less than about 5%, about 0.1% to about 4%, about 0.1% to about 3%, about 0.1% to about 2%, about 0.2% to about 5%, about 0.2% to less than about 5%, about 0.2% to about 4%, about 0.2% to about 3%, about 0.2% to about 2%, about 0.3% to about 2%, about 0.1% to about 0.5%, about 0.2% to about 0.5%, about 0.1% to about 0.4%, about 0.2% to about 0.4%, about 0.5% to about 2%, about 1% to about 2%, about 0.5% to about 1.5%, or about 1% to about 1.5% by weight ARA. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, comprising about 5% or less, less than about 5%, about 4% or less, about 3% or less, about 2% or less, about 1.5% or less, about 1% or less, about 0.5% or less, about 0.4% or less, about 0.3% or less, about 0.2% or less, or about 0.1% or less by weight ARA. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, which is substantially free of ARA. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, comprising about 0.4% to about 2%, about 0.4% to about 3%, about 0.4% to about 4%, about 0.4% to about 5%, about 0.4% to less than about 5%, about 0.5% to about 1%, about 0.5% to about 2%, about 0.5% to about 3%, about 0.5% to about 4%, about 0.5% to about 5%, about 0.5% to less than about 5%, about 1% to about 2%, about 1% to about 3%, about 1% to about 4%, about 1% to about 5%, or about 1% to less than about 5% by weight DPA n-6. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, comprising about 5%, less than about 5%, about 4% or less, about 3% or less, about 2% or less, about 1% or less, about 0.75% or less, about 0.6% or less, or about 0.5% or less by weight DPA n-6. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, which is substantially free of DPA n-6. In some embodiments, omega-3 or omega-6 HUFAs are provided from a microbial oil and/or one or more fractions thereof selected from the triacylglycerol fraction, the diacylglycerol fraction, the sterol fraction, the sterol esters fraction, the free fatty acids fraction, the phospholipid fraction, and combinations thereof, comprising fatty acids with about 5% or less, less than about 5%, about 4% or less, about 3% or less, or about 2% or less by weight of oleic acid (18:1 n-9), linoleic acid (18:2 n-6), linolenic acid (18:3 n-3), eicosenoic acid (20:1 n-9), erucic acid (22:1 n-9), stearidonic acid (18:4 n-3), or combinations thereof.

The triacylglycerol molecule contains 3 central carbon atoms (C(sn-1)H₂R1-(sn-2)H₂R2-C(sn-3)H₂R3), allowing for formation of different positional isomers. In some embodiments, omega-3 or omega-6 HUFAs are provided from a microbial oil comprising a triacylglycerol fraction in which at least about 2%, at least about 3%, at least about 5%, at least about 10%, at least about 15%, at least about 20%, at least about 30%, at least about 35%, or at least about 40% of the triacylglycerols in the triacylglycerol fraction contain DHA at two positions in the triacylglycerol (di-substituted DHA) selected from any two of the sn-1, sn-2, and sn-3 positions, based on the relative area percent of peaks on an HPLC chromatograph. In some embodiments, omega-3 or omega-6 HUFAs are provided from a microbial oil comprising a triacylglycerol fraction in which about 2% to about 55%, about 2% to about 50%, about 2% to about 45%, about 2% to about 40%, about 2% to about 35%, about 2% to about 30%, about 2% to about 25%, about 5% to about 55%, about 5% to about 50%, about 5% to about 45%, about 5% to about 40%, about 5% to about 35%, about 5% to about 30%, about 5% to about 25%, about 10% to about 55%, about 10% to about 50%, about 10% to about 45%, about 10% to about 40%, about 10% to about 35%, about 10% to about 30%, about 10% to about 25%, about 10% to about 20%, about 20% to about 40%, about 20% to about 35%, or about 20% to about 25% of the triacylglycerols in the triacylglycerol fraction contain. EPA at two positions in the triacylglycerol selected from any two of the sn-1, sn-2, or sn-3 positions, based on the relative area percent of peaks on an HPLC chromatograph. In some embodiments, omega-3 or omega-6 HUFAs are provided from a microbial oil comprising a triacylglycerol fraction in which at least about 0.5%, at least about 1%, at least about 1.5%, or at least about 2% of the triacylglycerols in the triacylglycerol fraction contain DHA at all of the sn-1, sn-2, and sn-3 positions (tri-substituted DHA), based on the relative area percent of peaks on an HPLC chromatograph. In some embodiments, omega-3 or omega-6 HUFAs are provided from a microbial oil comprising a triacylglycerol fraction in which about 0.5% to about 5%, about 0.5% to about 3%, about 0.5% to about 2.5%, about 0.5% to about 2%, about 1% to about 5%, about 1% to about 3%, or about 1% to about 2% of the triacylglycerols in the triacylglycerol fraction contain DHA at all of the sn-1, sn-2, and sn-3 positions, based on the relative area percent of peaks on an HPLC chromatograph. In some embodiments, omega-3 or omega-6 HUFAs are provided from a microbial oil comprising a triacylglycerol fraction in which at least about 10%, at least about 15%, at least about 20%, at least about 25%, at least about 30%, at least about 35%, at least about 40%, at least about 45%, at least about 50%, at least about 55%, or at least about 60% of the triacylglycerols in the triacylglycerol fraction contain DHA at one position in the triacylglycerol selected from any one of the sn-1, sn-2, or sn-3 positions, based on the relative area percent of peaks on an HPLC chromatograph. In some embodiments, omega-3 or omega-6 HUFAs are provided from a microbial oil comprising a triacylglycerol fraction in which about 10% to about 80%, about 10% to about 70%, about 10% to about 60%, about 15% to about 80%, about 15% to about 75%, about 15% to about 70%, about 15% to about 65%, about 15% to about 60%, about 35% to about 80%, about 35% to about 75%, about 35% to about 65%, about 35% to about 60%, about 40% to about 80%, about 40% to about 75%, about 40% to about 70%, about 40% to about 65%, about 40% to about 60%, or about 40% to about 55% of the triacylglycerols in the triacylglycerol fraction contain DHA at one position in the triacylglycerol selected from any one of the sn-1, sn-2, and sn-3 positions, based on the relative area percent of peaks on an HPLC chromatograph.

In some embodiments, omega-3 or omega-6 HUFAs are in the form of at least one of highly purified algal oil comprising 70% or more of the desired HUFAs, triglyceride oil combined with phospholipid, phospholipid, protein and phospholipid combination, or dried marine microalgae. An algal oil comprising 70% or more of omega-3 or omega-6 HUFAs can be obtained, e.g., by subjecting an algal oil to fractionation, distillation and/or concentration techniques.

Omega-3 or omega-6 HUFAs can be purified to various levels by any means known to those of skill in the art. In some embodiments, purification can include the extraction of total oil from an organism which produces omega-3 or omega-6 HUFAs. In some embodiments, omega-3 and/or omega-6 HUFAs are then removed from the total oil, for example, via chromatographic methods. Alternatively, purification can be achieved by extraction of total oil from an organism which produces DHA, but produces little, if any, amount of EPA and/or ARA.

Microbial oils useful in the processes herein can be recovered from microbial, algal, or marine sources by any suitable means known to those in the art. For example, the oils can be recovered by aqueous extraction and/or extraction with solvents such as hexane, isopropyl alcohol or water, or by supercritical fluid extraction. Alternatively, the oils can be extracted using extraction techniques, such as are described in U.S. Pat. No. 6,750,048 and WO 01/053512, both of which are incorporated herein by reference in their entireties.

Additional extraction and/or purification techniques are taught in WO01076715; WO01076385; U.S. Pub. No. 20070004678; U.S. Pub. No. 20050129739; U.S. Pat. No. 6,399,803; and WO01051598; all of which are incorporated herein by reference in their entireties. The extracted oils can be evaporated under reduced pressure to produce a sample of concentrated oil material. Processes for the enzyme treatment of biomass for the recovery of lipids are disclosed in WO2003092628; U.S. Pub. No. 20050170479; EP Pub. No. 0776356, and U.S. Pat. No. 5,928,696, all of which are incorporated herein by reference in their entireties.

Oil seeds, such as soybean, flax, sunflower, safflower, rapeseed and canola for example, are also useful as sources of HUFAs. In some embodiments, oil seeds that have been genetically modified to increase HUFA content can be employed. The oil extracted from the seeds can be also used. Methods of extracting oil from seeds are known to those skilled in the art. Animal sources, such as fish and fish oil, can also be used as a source of HUFAs.

In some embodiments, DHA can be prepared as esters using a method comprising (a) reacting a composition comprising polyunsaturated fatty acids in the presence of an alcohol and a base to produce an ester of a polyunsaturated fatty acid from the triglycerides; and (b) distilling the composition to recover a fraction comprising the ester of the polyunsaturated fatty acid, optionally wherein the method further comprises (c) combining the fraction comprising the ester of the polyunsaturated fatty acid with urea in a medium, (d) cooling or concentrating the medium to form a urea-containing precipitate and a liquid fraction, and (e) separating the precipitate from the liquid fraction. See, e.g., U.S. Pub. No. 20090023808, incorporated by reference herein in its entirety. In some embodiments, the purification process includes starting with refined, bleached, and deodorized oil (RBD oil), then performing low temperature fractionation using acetone to provide a concentrate. The concentrate can be obtained by base-catalyzed transesterification, distillation, and silica refining to produce DHA.

Preferred sources of phospholipids comprising omega-3 or omega-6 HUFAs include poultry eggs, enriched poultry eggs, algae, plants, plant seeds, fish, fish eggs, and genetically engineered algae, plants, and plant seeds.

In some embodiments, a milk of the invention can be further processed to produce a dairy product. In some embodiments, a dairy product is a food product wherein one of the major constituents is, or is derived from, a milk of the invention. In some embodiments, a dairy product can be yogurt, sour milk, cream, half & half, butter, condensed milk, dehydrated milk, coffee whitener, coffee creamer, nondairy creamer, smoothies, ice cream, kefir, or cottage cheese. Methods for processing a milk into a dairy product are known and described, for example, in Dairy Science and Technology, 2^{nd} ed. Walstra et al., Culinary and Hospitality Industry Publication Services, 2005.

In some embodiments, a milk or a dairy product of the present invention contains 0.5% or less by weight of fat on a wet basis. In some embodiments, a milk or a dairy product of the present invention contains 0.4% or less by weight of fat on a wet basis. In some embodiments, a milk or a dairy product of the present invention contains 0.3% or less by weight of fat on a wet basis. In some embodiments, a milk or a dairy product of the present invention contains 0.2% or less by weight of fat on a wet basis. In some embodiments, a milk or a dairy product of the present invention contains 0.1% or less by weight of fat on a wet basis. In some embodiments, a milk or a dairy product of the present invention contains 0.05% or less by weight of fat on a wet basis. In some embodiments, a milk or a dairy product of the present invention contains 0.01% or less by weight of fat on a wet basis.

In some embodiments, a milk or a dairy product of the present invention contains 0.5% to 0.01% by weight of fat on a wet basis. In some embodiments, a milk or a dairy product of the present invention contains 0.4% to 0.01% by weight of fat on a wet basis. In some embodiments, a milk or a dairy product of the present invention contains 0.3% to 0.01% by weight of fat on a wet basis. In some embodiments, a milk or a dairy product of the present invention contains 0.2% to 0.01% by weight of fat on a wet basis. In some embodiments, a milk or a dairy product of the present invention contains 0.1% to 0.01% by weight of fat on a wet basis. In some embodiments, a milk or a dairy product of the present invention contains 0.5% to 0.2% by weight of fat on a wet basis. In some embodiments, a milk or a dairy product of the present invention contains 0.4% to 0.2% by weight of fat on a wet basis.

In some embodiments, a milk or a dairy product of the present invention is a liquid. In some embodiments, a milk or a dairy product of the present invention is a powder.

In some embodiments, a milk or a dairy product of the present invention can be incorporated into a composition including one or more additives. In some embodiments, an additive can be an ingredient permitted under the federal standards of 21 C.F.R. §131.110, such as characterizing flavoring ingredients (with or without coloring, nutritive sweeteners, emulsifiers or stabilizers). In some embodiments, an additive for a milk or dairy product of the present invention can be a soluble or water soluble mineral, zinc, chromium, vitamin A, vitamin D, calcium, folic acid, vitamin E, tocotrienols, vitamin D, magnesium, phosphorus, vitamin-K, iron, B₁₂, niacin, thiamine, riboflavin, biotin, B₆, ginger or mixtures thereof.

The invention also relates to processes for making a supplemented milk or dairy product, comprising combining at least one omega-3 and/or omega-6 HUFA and a milk. In some embodiments, the invention also relates to processes for making a supplemented milk or dairy product, comprising combining at least one omega-3 and/or omega-6 HUFA, a milk, and one or more additives. In some embodiments, the amount of omega-3 or omega-6 HUFAs present in a milk or a dairy product is from 0.5 mg to 300 mg per serving of milk or dairy product. In some embodiments, the amount of omega-3 or omega-6 HUFAs present in a milk or a dairy product is from 0.5 mg to 300 mg per 250 g of milk or dairy product. In some embodiments, the amount of omega-3 or omega-6 HUFAs present in a milk or a dairy product is from 0.5 mg to 300 mg per serving of milk or dairy product. In some embodiments, the amount of omega-3 or omega-6 HUFAs present in a milk or a dairy product can be at least 0.5 mg, at least 1 mg, at least 5 mg, at least 10 mg, at least 15 mg, at least 20 mg, at least 21 mg, at least 22 mg, at least 23 mg, at least 24 mg, at least 25 mg, at least 26 mg, at least 27 mg, at least 28 mg, at least 29 mg, at least 30 mg, at least 31 mg, at least 32 mg, at least 33 mg, at least 34 mg, at least 35 mg, at least 36 mg, at least 37 mg, at least 38 mg, at least 39 mg, at least 40 mg, at least 41 mg, at least 42 mg, at least 43 mg, at least 44 mg, at least 45 mg, at least 46 mg, at least 47 mg, at least 48 mg, at least 49 mg, at least 50 mg, at least 55 mg, at least 60 mg, at least 70 mg, at least 75 mg, at least 80 mg, at least 85 mg, at least 90 mg, at least 100 mg, at least 110 mg, at least 120 mg, at least 130 mg, at least 140 mg, at least 150 mg, at least 160 mg, at least 170 mg, at least 180 mg, at least 190 mg, at least 200 mg, at least 210 mg, at least 220 mg, at least 230 mg, at least 240 mg, at least 250 mg, at least 260 mg, at least 270 mg, at least 280 mg, at least 290 mg, or at least 300 mg per serving of milk or dairy product, and useful ranges can be selected between any of these values (for example, from 1 mg to 300 mg per serving of milk or dairy product, 5 mg to 60 mg per serving of milk or dairy product, from 10 mg to 50 mg per serving of milk or dairy product, or from 20 mg to 50 mg per serving of milk or dairy product).

The present invention relates to a milk supplemented with omega-3 or omega-6 HUFAs that can have improved stability. In some embodiments, a milk or dairy product having improved stability is the resulting product of a pasteurization process of the invention. In some embodiments, a milk or dairy product supplemented with omega-3 or omega-6 HUFAs can have an increased shelf life compared to a milk or dairy product that is not subjected to a pasteurization process of the invention. In some embodiments, a milk or dairy product supplemented with omega-3 or omega-6 HUFAs can have reduced HUFA oxidation levels compared to a milk or dairy product that is not subjected to a pasteurization process of the invention. In some embodiments, a milk or dairy product supplemented with omega-3 or omega-6 HUFAs can have increased antioxidant levels and/or chelating ability (e.g., the result of a Maillard reaction) compared to a milk or dairy product that is not subjected to a pasteurization process of the invention. In some embodiments, a milk or dairy product supplemented with omega-3 or omega-6 HUFAs can have reduced fishy aroma or aromatics (e.g., by sensory testing) compared to a milk that is not subjected to a pasteurization process of the invention.

In some embodiments of the invention, a milk or dairy product supplemented with omega-3 or omega-6 HUFAs has a shelf life of at least 21 days, at least 22 days, at least 23 days, at least 24 days, at least 25 days, at least 26 days, at least 27 days, at least 28 days, at least at least 29 days, at least 30 days, at least 31 days, at least 32 days, at least 33 days, at least 34 days, at least 35 days, at least 36 days, at least 37 days, at least 38 days, at least 39 days, at least 40 days, at least 41 days, at least 42 days, at least 43 days, at least 44 days, at least 45 days, at least 46 days, at least 47 days, at least 48 days, at least 49 days, at least 50 days, at least 51 days, at least 52 days, at least 53 days, at least 54 days, at least 55 days, at least 56 days, at least 57 days, at least 58 days, at least 59 days, at least 60 days, at least 61 days, at least 62 days, at least 63 days, at least 64 days, at least 65 days, at least 66 days, at least 67 days, at least 68 days, at least 69 days, at least 70 days, at least 71 days, at least 72 days, at least 73 days, at least 74 days, at least 75 days, at least 76 days, at least 77 days, at least 78 days, at least 79 days, or at least 80 days, and useful ranges can be selected between any of these values (for example, from 21 days to 80 days, 30 days to 80 days, 30 days to 60 days, 45 days to 60 days, or 30 days to 45 days).

Milk or dairy product supplemented with omega-3 or omega-6 HUFAs can have increased antioxidant levels compared to a milk or dairy product supplemented with omega-3 or omega-6 HUFAs that is not subjected to a process of the present invention.

Additional objects, advantages, and novel features of this invention will become apparent to those skilled in the art upon examination of the following examples thereof, which are not intended to be limiting.

### EXAMPLES

### Example 1

The purpose of this example is to demonstrate the effects of heating on the shelf-life of milk supplemented with docosahexaenoic acid (DHA).

Skim milk samples (purchased from Safeway store, Lucerne non fat milk in gallon size) were fortified with DHA by adding 32 mg of DHA (DHA™-S oil product, Martek Biosciences Corporation, Columbia, Md.) per 250 g of milk (approximately one serving). Next, the samples were subjected to a preheating temperature (“preheat temp”) for a specified time (“preheat time”) and then sterilized using a direct steam injection process using MicroThermics™ (Raleigh, N.C.) as described herein. As detailed in Table 1, samples were subjected to preheat temperatures of 185° F., 205° F., 215° F., 225° F., and 245° F. for a preheat time of 3 seconds, 15 seconds, 45 seconds, 90 seconds, 135 seconds, 180 seconds, 210 seconds, 240 seconds, or 300 seconds. Following preheating, the samples were processed at 295° F. for 3 seconds to achieve microbial safety and the desired shelf life.

The aromatics of the fortified samples were evaluated at the end of shelf life (60 and 67 days) using the test method described below.

A difference-from-control sensory test (DFC) was conducted. Panelists were provided with blind coded samples and instructed to compare the unfortified sample (control) to all the other variables fortified with DHA, to determine if a difference exists between them. Panelists were also instructed to measure the size of the difference, if any, on the 7 point scale of 0-6, with 0 being no difference and 6 being a very large difference (Sensory Evaluation Techniques, 3rd edition, Meilgaard, M. et al. eds., CRC Press (1999)).

An informal benchtop screening of the fortified samples was also performed throughout the shelf life. Both the control and fortified samples were blind coded and compared, to see if a difference in the sensory results was perceived. The size of the perceived difference was measured using the 0-6 DFC scale, and the nature of the difference, if any, was indicated in the sensory results. The sensory results of the informal screening are shown in Table 1.

TABLE 1
Results of informal screening of skim milk fortified with DHA.
Sensory Results From Informal Screening

| | |
|---|---|
| Preheat time | |
| (sec) | Fishy aromatics developed between days: |

Preheat temp = 185° F.

| | |
|---|---|
| 15 | 13-19 |
| 90 | 24-31 |
| 180 | 28-34 |
| 210 | 0-20 |
| 240 | 29-45 |
| 300 | 32-46 |

Preheat temp = 205° F.

| | |
|---|---|
| 15 | 13-19 |
| 90 | 31-46 |
| 180 | 45-55 |
| 210 | 20-25 |
| 240 | 27-29 |
| 300 | 32-46 |

Preheat temp = 215° F.

| | |
|---|---|
| 3 | 0-13 |
| 90 | 31-35 |

Preheat temp = 225° F.

| | |
|---|---|
| 3 | (no fishy aromatics at 67 days) |
| 15 | (no fishy aromatics at 67 days) |
| 45 | 40-55 |
| 90 | (no fishy aromatics at 67 days) |
| 135 | 39-45 |

Preheat temp = 245° F.

| | |
|---|---|
| 3 | (no fishy aromatics at 67 days) |
| 15 | (no fishy aromatics at 67 days) |
| 45 | 55-61 |
| 90 | (no fishy aromatics at 67 days) |
| 135 | 45-53 |

As shown in Table 1, increased preheat time at a given preheat temperature resulted in a general increase in the number of days before fishy aromatics were detected in the product and in a general increase in product shelf life. Furthermore, it appears possible that there is a minimum temperature requirement for achieving a 60-day shelf life. The shelf life of 60 days is usually used for extended shelf life milk sold in the market place. Samples treated with a pre-heat of 225° F. and higher generally lasted 60 days without fishy aromatics regardless of their preheat hold time. Additional sensory results obtained using a trained sensory panel and the DFC method are provided in Table 2.

TABLE 2
Results of sensory evaluation of skim milk fortified with DHA.
Sensory Results from Formal DFC Panel
Evaluation

| | | |
|---|---|---|
| Preheat Time | Sample | |
| (sec) | Age (days) | Panelist Comments |

Preheat Temperature = 185° F.

| | | |
|---|---|---|
| 240 | 50 | Fishy aromatics |
| 300 | 50 | Fishy aromatics |

Preheat Temperature = 205° F.

| | | |
|---|---|---|
| 240 | 50 | Fishy aromatics |
| 300 | 50 | Fishy aromatics |

Preheat Temperature = 215° F.

| | | |
|---|---|---|
| 3 | 50 | Fishy aromatics |
| 90 | 50 | Fishy aromatics |

Preheat Temperature = 225° F.

| | | |
|---|---|---|
| 3 | 50 | No fishy aromatics |
| | 60 | No fishy aromatics |
| | 67 | No fishy aromatics |
| 15 | 60 | Fishy aromatics |
| 45 | 58 | No fishy aromatics |
| | 67 | Fishy aromatics |
| 90 | 50 | No fishy aromatics |
| | 50 | Fishy aromatics |
| | 60 | No fishy aromatics |
| | 67 | No fishy aromatics |
| | 71 | No fishy aromatics |
| 135 | 54 | No fishy aromatics |
| | 60 | No fishy aromatics |
| | 67 | No fishy aromatics |

Preheat Temperature = 245° F.

| | | |
|---|---|---|
| 3 | 50 | No fishy aromatics |
| | 60 | No fishy aromatics |
| | 67 | No fishy aromatics |
| 15 | 60 | No fishy aromatics |
| 45 | 58 | No fishy aromatics |
| | 67 | No fishy aromatics |
| 90 | 50 | No fishy aromatics |
| | 60 | No fishy aromatics |
| | 67 | No fishy aromatics |
| | 71 | No fishy aromatics |
| 90 | 58 | No fishy aromatics |
| | 69 | No fishy aromatics |
| | 50 | No fishy aromatics |
| | 60 | No fishy aromatics |
| 135 | 54 | No fishy aromatics |
| | 60 | No fishy aromatics |
| | 67 | No fishy aromatics |

As shown in Table 2, the products resulting from a pre heat treatment greater than 225° F. generally had little to no fishy aromatics at around 50, 60, and/or 70 days.

The foregoing description of the invention has been presented for purposes of illustration and description. Furthermore, the description is not intended to limit the invention to the form disclosed herein.

All of the various aspects, embodiments, and options described herein can be combined in any and all variations.

All publications, patents, and patent applications mentioned in this specification are herein incorporated by reference to the same extent as if each individual publication, patent, or patent application was specifically and individually indicated to be incorporated by reference.

What is claimed is:

1. A process for pasteurizing a milk or dairy product comprising omega-3 or omega-6 highly unsaturated fatty acids (HUFAs), comprising:
(a) heating the milk or dairy product to a temperature of (i) at least 175° F. for more than 60 seconds, or (ii) greater than 215° F. for at least 0.1 second; and
(b) heating the milk or dairy product of (a) to a temperature of 275° F. to 305° F. for at least 1 second;
wherein the milk or dairy product has a shelf life of at least 21 days.

2. The process of claim 1, wherein the temperature of (i) is 175° F. to 300° F.

3. The process of claim 1 or 2, wherein the temperature of (i) is 185° F. to 250° F.

4. The process of claim 1, wherein the temperature of (ii) is 225° F. to 245° F.

5. The process of any one of claims 1 to 4, wherein the heating of (i) is for 60 seconds to 300 seconds.

6. The process of any one of claims 1 to 5, wherein the heating of (i) is for 90 seconds to 300 seconds.

7. The process of any one of claims 1 to 6, wherein the heating of (ii) is for 3 seconds to 45 seconds.

8. The process of any one of claims 1 to 7, wherein the heating of (ii) is for 3 seconds to 15 seconds.

9. The process of any one of claims 1 to 8, wherein the heating of (b) is for 1 second to 5 seconds.

10. The process of any one of claims 1 to 9, wherein the milk or dairy product has a shelf life of at least 45 days.

11. The process of any one of claims 1 to 10, wherein the milk or dairy product has a shelf life of at least 60 days.

12. The process of any one of claims 1 to 11, wherein the heating of (a) promotes a Maillard reaction.

13. The process of any one of claims 1 to 12, wherein the heating of (a) increases an antioxidant level in the milk or dairy product.

14. The process of any one of claims 1 to 13, wherein the heating of (a) reduces oxidation of the omega-3 or omega-6 HUFAs.

15. The process of any one of claims 1 to 14, wherein the heating of (a) is performed by direct heating.

16. The process of any one of claims 1 to 14, wherein the heating of (a) is performed by indirect heating.

17. The process of any one of claims 1 to 16, wherein the omega-3 or omega-6 HUFAs are provided in the form of an algal oil comprising the omega-3 or omega-6 HUFAs.

18. The process of any one of claims 1 to 17, wherein the milk or dairy product contains 0.5% or less by weight of fat on a wet basis.

19. The process of any one of claims 1 to 18, wherein the omega-3 HUFAs comprise at least one of docosahexaenoic acid C22:6(n-3) (DHA), docosapentaenoic acid C22:5(n-3) (DPAn-3), eicosapentaenoic acid C20:5(n-3) (EPA), stearidonic acid C18:4(n-3) (SDA), and linolenic acid C18:3(n-3) (LNA).

20. The process of any one of claims 1 to 19, wherein the omega-6 HUFAs comprise at least one of arachidonic acid C20:4(n-6) (ARA), C22:4(n-6), omega-6 docosapentaenoic acid C22:5(n-6) (DPAn-6), gamma linolenic acid C18:3(n-6) (GLA), and dihomo gamma linolenic acid C20:3(n-6) (dihomo GLA).

21. A milk or dairy product processed according to any one of claims 1 to 20.
